(19) United States
(12) Patent Application Publication
(10) Pub. No.: US 2026/0367417 A1
(43) Pub. Date: Nov. 19, 2026

(54) SYSTEM AND METHOD FOR MOTORLESS VARIABLE SPEED HOLOGRAPHIC FAN

(71) Applicant: Abdulelah ALMADHI, Singapore (SG)

(72) Inventor: Abdulelah ALMADHI, Singapore (SG)

(21) Appl. No.: 19/136,867

(22) PCT Filed: May 12, 2023
(86) PCT No.: PCT/SG2023/050810

§ 371 Date: Jun. 7, 2025

Related U.S. Application Data
(60) Provisional application No. 63/430,923, filed on Dec. 7, 2022.

(51) Int. Cl. G02B 30/54; F21V 33/00; G03H 1/04

(52) U.S. Cl. CPC G02B 30/54; F21V 33/0096; G03H 1/04

(57) ABSTRACT

A novel system is described to display holograms comprised of 3D imagery wherein the display unit has a structure of a fan with a plurality of blades, each blade carrying a plurality of RGB LEDs wherein the system is either mounted on an external rotating mechanical assembly using a mounting adapter or embedded into the rotating mechanical assembly. The hologram appears orthogonal to the shaft of rotating mechanical assembly. A key method of invention is estimating and adjusting the sampling interval for lighting of LEDs at variable rotation speeds through an intelligent controller that can sense the rotation speed.

### FIELD OF INVENTION

The invention generally relates to display of 3D images and specifically displays of holograms for 3D visuals finding use in marketing, medicine, military, and art. More specifically, it relates to animated holographic displays of a fan structure with a plurality of rotating blades rotating at variable speeds.

### BACKGROUND

Holographic displays tend to attract a consumer's attention, and are capable of providing more details than what a typical marketing material can offer. The following includes information provided for understanding various aspects of the present disclosure.

### BRIEF SUMMARY OF INVENTION

Any discussion of the prior art throughout the specification should in no way be considered as an admission that such prior art is widely known or forms part of common general knowledge in the field.

The present disclosure provides a novel holographic fan system that is mountable on a variety of different types of rotational assemblies for display by using different mounting adapters. The general purpose of the present disclosure that will be described in greater detail in subsequent sections is to provide inexpensive, extremely light, and flexible LED system of a fan arrangement without requiring an internal motor. The system of invention leverages the rapid rotation of a rotational assembly that is an external device such as (I) a vehicle's wheel (car, van, bus, or truck), a helicopter shaft or drone shaft that starts/stops and rotates at variables speeds, or (ii) a cooling or computer fan shaft that rotates at a fixed or discrete speeds.

A light-emitting diode (LED) is a semiconductor that emits light when electric current flows through it. The Red, Green, and Blue (RGB) LEDs have three internal diodes that can be combined to produce any desired color output. To produce different colors, the intensity of each internal diode is set and the three color outputs are combined. RGB LEDs can be used in different applications such as outdoor decoration lighting, stage lighting designs, home decoration lighting, LED matrix displays and holograms. They are considered as low power consuming bulbs (less than 10 watts per bulb).

One of the key uses of RGB LEDs is in generating light within holographic displays. A conventional holographic fan is one of holographic display technologies that produce a 3D image seemingly floating in the air using the principle of POV (Persistence of Vision) that takes advantage of the laziness of the eye. The eye can't track motion above a certain speed due to a dead-time of eye's optical nerves during the acquisition and processing of an optical signal. A POV LED display composes images by displaying one spatial portion at a time at a high frequency (e.g., one column or row of the pixels every few microseconds). A two-dimensional POV LED display is often accomplished by means of rapidly moving a single row of LEDs along a linear or circular path. The image is realized by the viewer so long as the entire path is completed during the visual persistence time of the human eye. A further effect is the illusion of an image floating in mid-air. A three-dimensional POV display is often constructed only by using a 2D grid of LEDs which is either swept or rotated fast. The 3D holographic display is achieved by feeding a sequence of 2D images to a 2D grid of LEDs.

In a fan hologram, strips of RGB LEDs are mounted on thin blades in a rotating fan structure. A controller lights up the LEDs as blades rotate to produce and display a full 3D image visible in the air. The rotation of blades is crucial as it enables the use of much fewer number of LEDs to produce a good quality image. The light emitted by each LED appears essentially at different positions in a circular trajectory as the blade carrying the LED rotates. Alternative implementations exist using fixed (non-rotational) matrix-based LED panels as in in LED TVs. However, these static panels would require much larger number of LEDs to produce the same quality image (hence need more power) and become much more expensive.

The 3D image content for holographic display can be created using a software application. For example, several software tools with graphical user interface (GUI) exist in prior art that can convert 2D image content such as a logo into a 3D image using only graphical processing. The generated media is digitally stored in pixels in well-known formats such as .mov, .mp4 or .avi. A hologram is also created by the interference of light waves. Light from a single source is split into two beams. The first beam is used to illuminate the object to be photographed. The second beam (also known as reference beam) is routed around the object, without interaction. The light reflected from the object and the untouched light are then combined. As a result, an interference pattern is generated which is then captured as the holographic film media. Holograms can also be software generated by modelling these two light waves and adding them together digitally.

The digital hologram file is a 3D image file that is comprised of many 2D images is used to determine which RGB diodes in an LED to light up and at what intensity to generate the color to reconstruct the image of interest in mid-air. If each LED turns at a certain speed, (e.g., using a rotating blade) then their position on its circular path is estimated in real-time. Accordingly, the LED's color is altered to generate a 3D image's pixel structure using the software that has access to stored holograph file.

Recently several simple 3D LED fan holographic systems have emerged in the market for mostly indoor and window displays of commercial product advertisements and for art displays. In all these systems, a realistic and fine-granularity 3D color image that is either static or animated appears in front of the fan. These systems that mount on a wall or ceiling provides 2, 4 or 8 blade fan alternatives with RGB LED lights on the blades. They contain an internal motor (stator, rotor and brush components) that rotate the blades at a constant speed (e.g., 500 rpm), and a printed circuit board (PCB)-based microcomputer that has software configured to light up the LEDs to generate the hologram. The power required to operate the microcomputer and the LEDs is provided by an internal battery. They all provide a companion control unit to remotely configure and control the holographic fan (e.g., turn on/off, select hologram duration, select 3D image) using a wireless connectivity to the fan's computer. The weight of the unit due to rotational componentry is generally in the range of 1.5 Kg to 2.5 Kg. Some of these systems offer cloud-based storage of holograms and even tools to generate 3D content.

According to various embodiments of this invention, the holographic fan is used on different types of rotating systems which rotate at different, and in some cases (such as a vehicle's tire) at a highly variable rotational speed in time. It is a great challenge to adjust the display of the hologram at variable speed, which is not taught by any prior art systems.

An emerging interesting application of holograms is content display on moving vehicles such as cars, vans, buses, trucks and unmanned vehicles. In prior art, there is a vast range of references on static content display on vehicles mainly for advertisements. When advertising messages are displayed on moving objects, such as buses and other commercial vehicles, those advertisements are generally images displayed on the surface of the vehicle. As such, advertisements are not easily altered. Accordingly, there is a need that is identified for a new system for displaying information on moving vehicles and controlling the content of the display.

In US U.S. Pat. No. 948,377, a system that comprises a frame configured to be mounted on the vehicle adjacent to license plate area of the vehicle is described to display a high-resolution 2D video content which is controlled through software. To fulfill the need of displaying variable content, an OLED-based TV panel is described that is mounted on a vehicle in Korean patent application number KR101626658B1, wherein the display content can again be modified through software. In US patent application number US2019/0096297A1, a mobile image projection system is mounted on a vehicle to project a 2D image on a surface of a vehicle body. The system includes a wireless network interface configured to communicate with a remote computing device to receive different display image files to be projected.

The use of holograms in moving vehicles has only been a very recent topic. In US patent application number 2020/0387932A1, a 3D holographic fan is installed on the roof of the car using a mount. This holographic fan has an internal motor that turns the shaft of the fan and connects to the electric wiring system of the car. The 3D image appears on top of the car.

As another potential use of holograms in moving vehicles, Chinese patent application CN114677930A discloses an unmanned aerial vehicle carrying a 3D holographic fan, which comprises a holographic fan body, display device, a constant-speed motor for driving the display device and a power supply, wherein the display device is radially arranged along a rotation shaft (in a fan structure). The patent document also describes a telescopic blade for supporting variable lengths that can be contracted and stored when being carried. A similar system is seen in Chinese utility patent application number CN213582889U that describes a 3D fan hologram wherein the blades are removable and pluggable for convenience purposes.

In U.S. Pat. No. 10,866,562, another interesting use of 3D holograms is described for vehicle onboard communications to generate and display 3D holographic objects, holographic digital assistance, and dynamically modified holographic contents in vehicle control, and occupant communications. Preferably, the vehicle onboard holographic communication system includes a vehicle infotainment hardware module and a holographic display pod integrated into a vehicle dashboard. The in-vehicle holographic display pod provides high resolution 3D holographic objects for vehicle occupant infotainment, vehicle control and communication applications. However, this system does not use a 3D fan-based system. Similarly, Chinese patent application CN213690110U teaches a vehicle-mounted holographic display device that is arranged in the inner space of a motor vehicle and used for displaying holographic images.

None of the cited references however describes the system of the present invention that is a 3D fan based holographic system that relies on the rotational component of another system such as a vehicle's wheel or a computer or ceiling fan and contains all assembly components including a processor and software to generate a hologram at highly variable speeds (as we see in a car wheel).

Embodiments of this invention provide a cheaper and flexible solution as it does not have the motor component required to rotate the blades. As a result, the system is much lighter (less than a pound) as many metal motor parts are no longer needed. The system complexity is lowered because of much smaller and highly compact system. Another advantage is faster implementation as it is purely electronic, i.e., no mechanical/rotational components (rotor, stator, coils, brushes, etc.) are needed. The system of invention is highly versatile as it works at variable speeds around a configurable reference speed. The reference speed is the fan speed at which a high quality static or animated hologram can be produced and displayed for a stored 3D image.

A key method of invention is the generation and display of the 3D image at variable rotational speeds without requiring a major computation of the corresponding LED pulse sequence that lights up each RGB diode according to stored image file's light intensity data. A fan speed sensor such as a tachometer is employed in the system of invention to estimate the rotational speed in real-time. Readily generated LED pulse sequence at a reference speed (say 500 rpm) is rescaled according to newly detected rotation speed by simply readjusting the sampling interval. This means that the LED pulses are sent more frequently as the rotation speed increases, and the LED pulses are sent less frequently when the rotation speed decreases. This computationally efficient method yields a variable sampling time interval dependent on the speed and provides the same quality image at higher or lower rotational speeds around the reference speed bound by a minimum allowable speed. If the method of invention is not used, the LED pulse sequence would need to be generated at each small increment of possible rotation speeds. Each said generated LED pulse sequence file will then be either prestored in a database or computed in real-time. These methods are therefore highly inefficient and computationally cumbersome. In stark contrast, this invention may generate and use only one LED pulse sequence file.

In one embodiment, the hologram fan assembly is attached to the external rotating assembly by a mounting adapter that can fit into a shalt of different fan types and models, or different vehicle wheel types/models and wheel sizes. By separating the mounting adapter, the rest of the hologram fan assembly components of this invention are identical for different use cases.

In another embodiment, the hologram fan assembly is embedded into an external rotating assembly such as a wheel hubcap, indoor/outdoor cooling fan or a computer fan. By embedding, the mounting adapter is no longer needed. The rest of the hologram fan assembly components are the same.

### SUMMARY OF THE INVENTION

The first embodiment of this invention is a 3D holographic fan system for display of 3D images, the fan consisting of, a non-motorized housing assembly that attaches to or embedded into a motorized and rotating system rotating at rotation speed that varies over time, the 3D holographic fan system including a fan blade assembly connected to a core rotatably and centrally mounted and attached to fan blade assembly, the fan blade assembly comprised of a plurality of fan blades extending from the core, and a linear string of (RGB) LEDs mounted on each fan blade, and a controller mounted within the core wherein the controller controls the electricity given each RGB LED wired to said core to reflect a 3D image (hologram) in the air in front of said 3D holographic fan assembly while the motorized and rotating system turns.

According to another aspect of invention, said core includes a plurality of connectors to electrically connect each (RGB) LED to a power supply located in the core, connector providing different intensity electricity to each individual LED for illumination during rotation of fan blades.

According to another aspect of invention said power supply is a DC battery, a lithium battery, or a slip ring.

According to another aspect of invention, said core further has a rotational speed sensor (e.g., tachometer) that monitors the rotational speed of a fan assembly, which may be an external rotating assembly (such as ceiling fan, wheel of a vehicle or propellers of an aerial instrument).

According to another aspect, the assembly further comprises a controller to control illumination of the one or more LEDs, the controller operatively connected to a wireless remote device and has a microcomputer with memory and processor that stores the 3D hologram image file and has the software that converts the 3D hologram image file (a sequence of 2D images) into each LED's illumination intensity that is stored in so called LED pulse sequence file corresponding to each 2D image and delivered as a pulse sequence according to a sampling time interval wherein said sampling time interval is re-adjusted according the changing rotation speed measured by said rotational speed sensor while the mapping of the 3D image file to each LED's illumination sequence is kept fixed, i.e., only one LED pulse sequence file is used.

According to another aspect, said controller has a method of controlling the display of hologram according to executing the following steps: (i) measure current rotation speed using rotational speed sensor; (ii) stop displaying hologram when current rotational speed is zero; (ii) otherwise, pause displaying hologram when current rotation speed is less than specified minimum speed, or the hologram display timer expires; (iv) otherwise, determine and display hologram using current sampling time interval, said determination is by taking the ratio of specified reference speed of rotation to current speed of rotation and multiplying said ratio by specified reference sampling time that is used when rotating system turns at reference speed.

According to another aspect, the controller is operatively connected to a wireless remote device that receives the 3D hologram image file to display from another remote storage system.

According to another aspect of invention, said core further has a solar sensor that activates the system only at dark.

According to another aspect, the core and fan blade assembly are attached to a mounting adapter that firmly fits the assembly to different type and size of motorized systems.

According to another aspect of invention, the motorized system is a computer fan to cool the computer components by circulating air.

According to another aspect of invention, the motorized system is any type of ceiling, window, desk, tower, pedestal, or handheld fan, or any type of fan mounted to a furniture for indoors and outdoors air cooling.

According to another aspect of invention, the motorized system is a car, truck, van or another type of vehicle's rotating wheel.

According to another aspect of invention, the motorized system is an unmanned aerial device or a helicopter.

These and other objects, features, and advantages of the present invention will become more readily apparent from the attached drawings and the detailed description of the preferred embodiments, which follow.

### BRIEF DESCRIPTION OF DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1a is a simple illustration of a prior art fan based holographic system.

FIG. 1b is an exemplary pulse sequence sent to RBG LEDs at discrete time intervals.

FIG. 1c is an illustration of LED positions during rotation.

FIG. 1d is another illustration showing LED positions on a circular trajectory.

FIG. 1e is an illustration of mapping of image pixels to LED positions during rotation.

FIG. 2 depicts a diagram of key components of the system of invention.

FIG. 3 depicts a high-level diagram of the subsystems of the controller.

FIG. 4 shows steps of the method of the controller at variable fan speed.

FIG. 5a shows a diagram of an exemplary embodiment of the system of invention.

FIG. 5b shows a diagram of an exemplary embodiment of the system of invention mounted on a cooling fan.

FIG. 5c shows a diagram of an exemplary embodiment of the system of invention embedded into a cooling fan.

FIG. 5d shows a diagram of an exemplary embodiment of the system of invention mounted into each blade of a cooling fan.

Skilled professionals will appreciate that elements in the figures are illustrated for simplicity and clarity and have not necessarily been drawn to scale. Also, common but well-understood elements that are useful or necessary in a commercially feasible embodiment are often not depicted to facilitate a less obstructed view of these various embodiments of the present invention. Flowchart and block diagrams in the figures illustrate the functionality and operation of possible implementations of systems, methods and computer program products according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### DETAILED DESCRIPTION

The detailed description contains explanations, formulations, diagrams, and flowcharts that are provided purely to enhance the understanding of the system components and the methods, and thus they may not describe all details or illustrate all trivial blocks and steps that would be understood by those persons skilled in art. Some of the figures are presented only for clarifying the terminology or to explain the prior art in contrast to present invention.

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, such embodiments aren't mutually exclusive, unless so stated and except as will be readily apparent to those of ordinary skill in the art. Thus, the present invention can include any variety of combinations and/or integrations of the embodiments described herein.

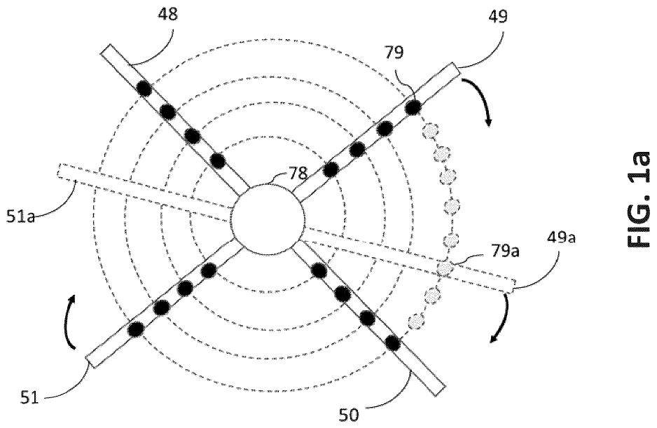

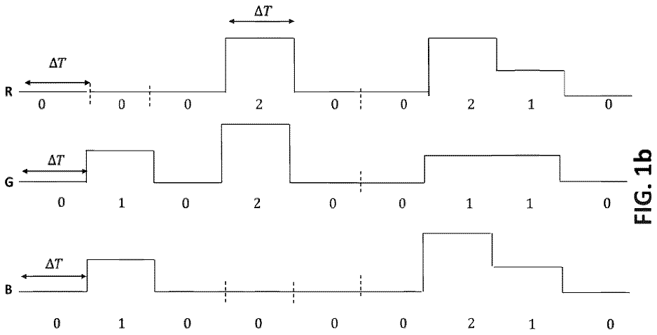

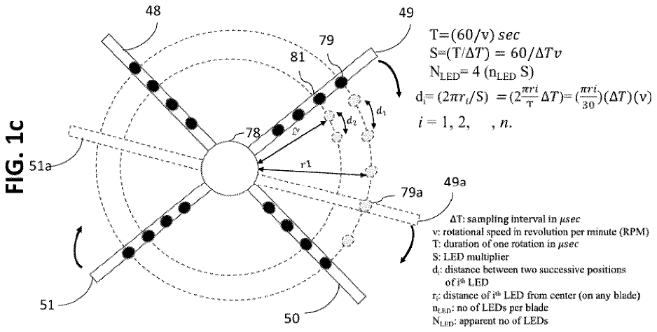

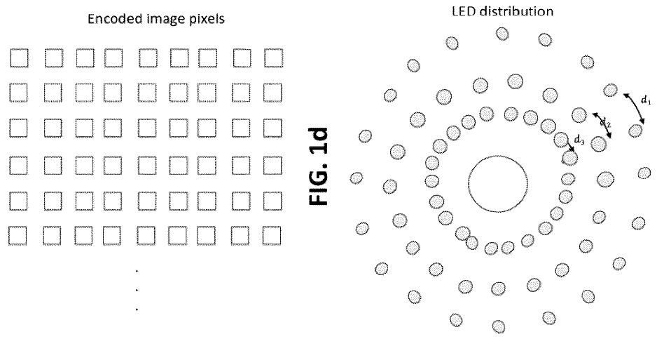

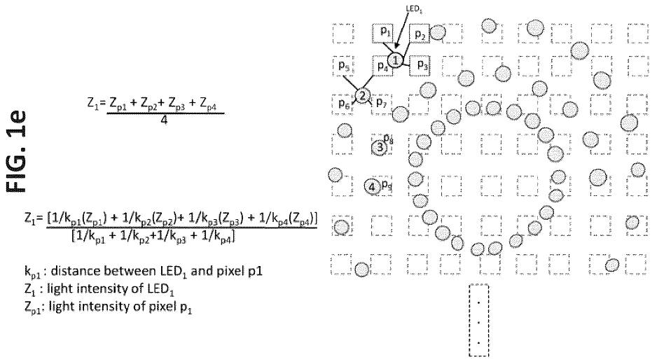

FIG. 1a shows a typical prior-art hologram fan system with four blades 48, 49, 50, and 51 wherein all blades rotate clockwise. Underneath each blade is a string of mounted RGB LEDs 79. Core 78 that turns with the blades at the same rotational speed typically houses a microprocessor, an electric connector, a power supply, and a DC electric motor comprised of a rotor, stator, commutator, and brushes. Each RGB LED has 3 diodes and 4 input/output (I/O) connectors—per red, green and blue diodes, and anode/cathode that are controlled by Core 78. Core 78 has the electric connector from the power supply to each diode to send an electric pulse. In LED display technology, the Surface Mount Device (SMD) concept is conveniently used wherein the red, green, and blue diodes are treated as electronic components that are surface mounted directly on a printed circuit board (PCB) and, not as previously, by soldering the metal pin on the underside of the circuit board. There will be no visible wires from the LEDs 79 to Core 78, but only connections on PCB that receive electric current. Packages of LEDs that are readily surface mounted are currently available in the form of chips. When the diodes are encapsulated in this way, they take up a lot less space, making it possible to produce displays with less spacing between the diodes and much higher resolution.

Instead of seeing individual lights emitted by each color diode, the eye sees a combined color. The LED's emitted color changes as the electric pulse sent to each diode has different power levels. The blades rotate at a reference speed during which each LED on a blade appears at a different position on a circular trajectory. Therefore, it is required to distinguish a LED that is physically installed on the blade from its appearances on a circular trajectory as the blade rotates. These appearances are called ‘virtual’ LED, for the lack of a better term. Note that if a LED is installed on the blade r distance away from the core, its circular trajectory would have a radius of r and trajectory length (or circumference) of 2πr. The closer the LED is located to the core, the smaller the radius and the shorter its circumference. The dotted lines in FIG. 1a show the trajectory of each physical LED while the blades rotate. For example, LED 79 appears at circular position 79a (a virtual LED) when the blade is at circular position 49a. The rotation of blades at a fast speed enables the use of fewer number of LEDs to attain a good image resolution as the rotation causes each physical LED to create more virtual LEDs on a circular trajectory, the intensity of which can be modified to attain POV. However, the blades must turn at least at a specified minimum speed (e.g., in the range of 500-750 rpm) to attain POV. Otherwise, the human eye starts seeing the blades' rotation instead of the hologram.

FIG. 1b shows an exemplary pulse sequence sent to R, G and B diodes. Here, ΔT is the pulse duration in time-domain also known as the ‘sampling interval’ or the ‘pulse width’. Note that during the 1^{st}, 2^{nd}, and 3^{rd} sampling intervals, no pulse is sent to diode R, while at 4^{th} sample, a pulse of intensity level of 2 is sent. Each pulse is an electric signal corresponding to an 8-bit binary number generated by a processor. Therefore, possible pulse signal levels are 2⁸=256. Each color on an image pixel is essentially decomposed to its R. G and B components, wherein each component is an 8-bit binary number (e.g., 01000110) which then gets maps into an electric signal corresponding to that level and sent to each diode at sampling intervals.

FIG. 1c is a simple illustration that shows where the LEDs appear on their circular trajectory as fan blades turn. When the blades turn at a speed of v rpm, the time it takes to complete a full turn (360°) is T=60/v sec. If the sampling interval is ΔT sec, then the total number of (virtual) LEDs, denoted as N_{LED}, is the number of physical LEDs multiplied by a factor of S=T/ΔT. Meaning, N_{LED}=4 (n×S) where n is the number of installed LEDs per blade in a 4-blade system. More generally, in an m-blade system wherein each blade has n LEDs, N_{LED} is found as m (n×S).

If LED 79 (LED₁) has a radius of r₁, it traverses an aro of length d₁ in each ΔT sec sampling interval as illustrated in FIG. 1c. If LED 81 (LED₂) is at distance r₂ away from the core where r₁>r₂, it traverses an arc of length d₂ during each ΔT sec sampling interval as illustrated in FIG. 1c where d₁>d₂. Meaning, the virtual LEDs that are closer to the core traverse smaller circular trajectories. Therefore, it appears as if there are more frequent virtual LEDs on the inner trajectories compared to outer trajectories. Let us assume a fan system with a string of n physical LEDs on each blade wherein each LED, is r₁ away from the core. Then, the formula for arch length d₁ for a LED at radius r₁, is simply:

$${d}_{\text{?}} = ( 2 π ri / S ) = ( 2 \frac{π ri}{T} Δ T ) = ( \frac{π ri}{30} ) ( Δ T ) ( v ) i = 1 , 2 … , n . \qquad Eq . ( 1 )$$

$$\text{?} \text{indicates text missing or illegible when filed}$$

From Eq (1), the arc length not only depends on the distance of the LED from the core, but also the multiplication of the sampling time interval and the speed of blade revolution. These two parameters can be used to attain a good resolution hologram image for the same number of LEDs on fan blades.

To illustrate the mapping from a digitally stored image file to generate a hologram to each LED's pulse sequence, a simple diagram is shown in FIG. 1d. On the left hand side of the figure, a 2D image pixel topology is stored as a rectangular 2D grid wherein each pixel has a value encoded to indicate the corresponding RGB color component of the image at that grid pixel. The squares indicate the pixels. On the right hand side of the figure, the (virtual) LED locations on circular trajectories of a simple fan system are shown. The circles indicate the virtual LEDs. The virtual LEDs on an outer trajectory appear farther apart from each other than those on the inner trajectories as shown in FIG. 1c. The image RGB encoding in this figure corresponds to a rectangular grid topology wherein LEDs to generate the hologram are of circular topology. So, a mapping is needed from rectangular to circular topology to estimate each LED's pulse sequence from the image file.

To illustrate the mapping from a digitally stored image file to LED pulse sequence, another simple diagram is shown in FIG. 1e, wherein the virtual LED positions are superimposed onto the encoded image pixels. Because the virtual LEDs appear on a circular topology, they do not overlap with the rectangular (grid) topology of pixels. Therefore, an interpolation is needed to get the color of each virtual LED from the pixel color values in its vicinity. If the LED overlaps with a pixel, as in p3 and p4, then the LED intensity is the same as that of the pixel. If the LED does not overlap with a pixel, as in pt and p2, then the LED intensity is obtained by approximation from its neighboring pixels. An exemplary method is averaging the pixel colors of the nearest four pixels around the LED's position. Another exemplary method is averaging the pixel colors of the nearest four pixels by weighting each pixel color by distance of that pixel to the LED position using a weighted-averaging method. The equations for said exemplary methods are given in the figure.

The mapping technique shown in FIG. 1e is dependent on the circular topology of the virtual LED distribution which is affected by the distance between two successive virtual LEDs on each circular trajectory, dᵢ (see Eq. 1), which is a function of the speed of rotation. Under a variable rotation speed, the locations of virtual LEDs on the trajectory changes. The higher the rotational speed, the longer the distance dᵢ for the same sampling time and the fewer the number of virtual LEDs there are. Therefore, the mapping from pixel topology to virtual LED topology changes. This results in requiring a computation of each LED's illumination under varying rotation speeds. Because of the required computation, all prior art fan hologram systems are designed for a single speed and single sampling interval in which case the mapping to image pixels is performed only once for each 2D image file.

A novel approach of the embodiments of the system of invention is enablement of the use of highly variable speed rotational systems such as a car wheel to rotate the fan blades without requiring computationally intensive re-mappings. This is achieved by adjusting sampling time duration under varying rotational speeds to keep dᵢ constant under varying rotation speed so that the virtual LED topology is fixed/constant. Inspecting Eq. (1), we determine that keeping d constant can be achieved only by keeping the multiplication of sampling time duration and the rotation speed (i.e., ΔTv) fixed. The following holds for a fixed LED topology:

ΔT(old)v(old)=ΔT(new)v(new) Eq. (2)

or,

ΔT(new)=ΔT(old)v(old)[v(new)] Eq. (3)

The result of Eq. (3) can be restated as ‘when speed of rotation increases, the sampling time must be proportionally reduced, and vice versa’. For example, if the sampling time ΔT was 5 when rotation speed is 500 rpm, then at 1000 rpm, the ΔT must be reduced to 2.5 to attain the same virtual LED topology. This means more frequent sampling or more frequently changing of the diode colors. The ramification is to sample more frequently at higher speeds, and less frequently at lower speeds. By increasing the sampling time ΔT, one can achieve good quality image even at somewhat lower rotational speeds. However, the rotation speed must be within a range of speeds that yields a good quality hologram display. Meaning, at very low speeds increasing ΔT will not yield the effects of POV. A so-called ‘reference speed’ will be determined, say 700 rpm, at which a good quality hologram will be delivered. Even at high rotational speeds, this method will yield an image quality corresponding to the reference speed. The allowed rotational speed range will be any variable speed above the minimum speed of say 500 rpm, wherein sampling interval is adjusted to deliver the hologram image quality corresponding to 700 rpm. Doing this creative scaling, the computationally intensive real-time mapping from 2D image file to LED pulse sequence at each speed is avoided.

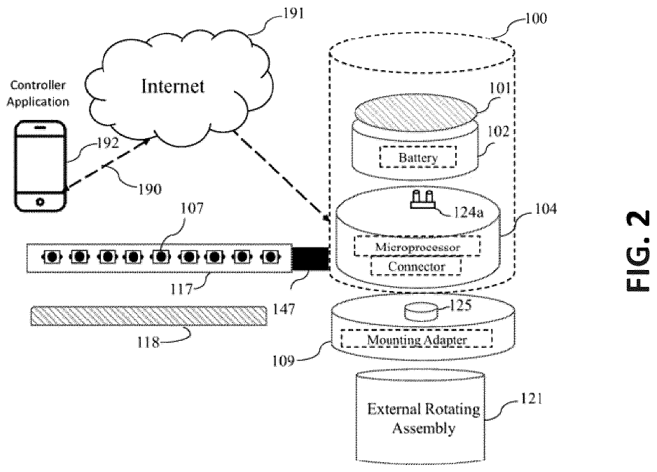

FIG. 2 depicts a diagram of key components of an exemplary holographic fan system (for display of a three-dimensional projection) attachable to an external rotating assembly such as a computer fan or a car wheel. Motor shaft 121 is the shaft on the external rotating system (that is not part of the exemplary system) to which the exemplary system attaches through mounting adapter 109. The exemplary system plugs into mounting adapter 109 through common mechanical connector 125. The exemplary system can be unplugged from one type of mounting adapter and plugged into another type of mounting adapter without any change using the common mechanical connector 125. The mounting adapter enables the exemplary system to turn at the same speed with the external rotating system. In another exemplary system, the system can be configured to attach directly and detachably with the motor shaft 121, so mounting adapter 109 is not required.

Mounting adapter 109 can take various forms depending on how the rotating assembly exposes an attachable rotating part. For car wheels, as an example, this may be the central part of the hubcap that is being attached to the tire with several lug nuts. The hubcap is a protective plastic assembly well known in prior art that is fitted to tire shaft. One possible embodiment of a mounting adapter is mountable on the outer side of the hubcap using the lug nuts. Another embodiment of a mounting adapter is a simple motor bracket (clamp) system that attaches to the core of a cooling fan. If the exemplary system is embedded into the rotating assembly (e.g., a hubcap, cooling fan or computer fan), then mounting adapter 109 is not required.

Core 100 is the heart of a hologram fan system (or hologram fan assembly) to which blades 117 connect. Each blade 117 has a plurality of RGB LEDs 107 that are mounted using SMD method on a thin PCB. Blade 117 is made of a light material such as plastic or aluminum. Blade 117 may be covered partially or fully with solar panel 118 which is shown in the figure as a separate and optional component. Blade 117 connects to Core 100 with connector 147. Core 100 is cylindrically shaped and provides peripherally a plurality of connectors 147 to attach variable number of blades such as two, four or eight blades. Each blade 117 firmly attaches to Core 100 from mechanical sense as well as electrically through connector 147. Core 100 can send different intensity levels to each diode of LED 107 of blade 117 using connector 147. Connector 147 is a solderless LED pin connector well known in prior art.

FIG. 2 also illustrates a local battery 102 that can be a lithium battery that provides DC power and is charged using solar panel 101 and, optionally, using solar panels 118 located on fan blade 117. The key component of Core 100 is controller 104 which is comprised of a processor and memory as well as electronic componentry such as transistors, resistances, and capacitors to convert digital to analog (D/A) signals to be sent to LEDS. Controller keeps in its memory the sequence of 2D image file(s) for generating the 3D image to display wherein the processor determines which LEDs to light up and what intensity to map the 3D image into light. Controller 104 is controlled by remote terminal 192 such as a cell phone that attaches to the system using wireless connection 191 over public Internet 190. Controller 104 can be connected to a suitable transceiver device (not shown in figures) to enable access to other network systems such as WIFI, Wide Area Network (WAN) or an external Bluetooth module. Remote terminal 192 can specify or change the configuration of the system (e.g., specify/change number of blades, specify/change number of LEDs per blade, reference speed, minimum speed, select hologram production file, etc.) and upload different 3D image files for display. For instance, there can be eight blades 117 connected to the core 100, and only four or six of the eight blades 117 are in operation according to configuration instructions sent by the controller 104 (e.g. this may occur when the speed is much higher than minimum speed). In another example, the minimum speed can be increased to increase the quality of the hologram generated. These files can be obtained by remote terminal 192 from a server in the cloud, or generated by the remote terminal 192 using a hologram generating application (executed by the processor), or received from the remote terminal 192.

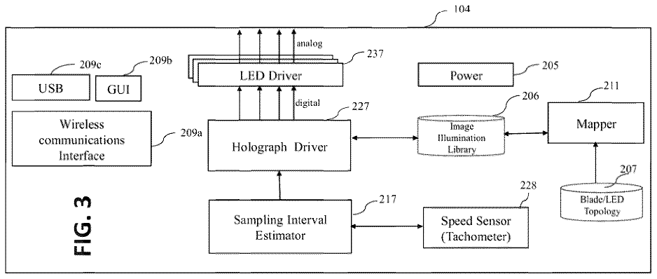

FIG. 3 is a high level block diagram of controller 104 showing various key functions executed in a processor and an electronic circuitry are illustrated in FIG. 2. Controller 104 provides various interfaces to its processor to access and configure its functions. (i) wireless communication interface 209a allows a remote terminal to connect and configure controller 104 via Wi-Fi, Bluetooth, or cellular protocols such as LTE and 5G; (ii) USB interface 209c provides access for a wired connection of another type of terminal such as a computer; (iii) GUI 209b is a graphical interface for specifying configurations. LED driver 237 is an electronic circuitry comprised of transistor, resistors, capacitors, etc. where electric pulses corresponding to digital numbers (binary sequences) are generated and send to each diode via connector 147 (shown in FIG. 2). This component has a D/A converter, well-known in prior art, wherein its input is a series of digital signals, and its output is series of analog signals. LED driver 237 attaches to holograph driver 227 which generates the binary sequence that represents the power level for each RGB diode corresponding to an image file. Controller 104 receives power for its functions from power 205 which is supplied by battery 102 shown in FIG. 2. Image and illumination library 206 holds in memory or in a database the hologram image file as well as the corresponding LED illumination (pulse sequence) mappings of each image file (see FIG. 1e for mappings). This library can store several image files (one for each hologram) and for each file the corresponding mappings file for a circular topology LED configuration. Blade/LED topology 207 stores the fan topology of the system in terms of number of blades and number of LEDs per blade. More blades can be added to the system or new blades with more LEDs as new hardware in which case the corresponding configuration is modified in blade/LED topology 207. Mapper 211 is the software component executed in the processor that maps the image file stored in memory 206 to corresponding LED illumination (pulse sequence) file using the blade/LED topology stored in memory 207. This mapping is performed only once for each image file at the reference speed. If the reference speed is modified through reconfiguration of the controller, the mappings must be recomputed. Speed sensor 228 monitors the speed of rotation in real-time, and reports to sample interval estimator 217 which then determines the sampling interval at the measured rotation speed. The calculated sampling interval is fed to holograph driver 227 which then sends the binary sequence at that specified sampling interval for each RGB diode to LED driver 237 to convert each binary sequence to an electric pulse and light up the diodes at the computed intensities at specified sampling intervals. For this operation, the reference rotational speed (e.g., 700 rpm) must be configured as well as the minimum tolerable rotation speed (e.g., 500 rpm) to take advantage of POV.

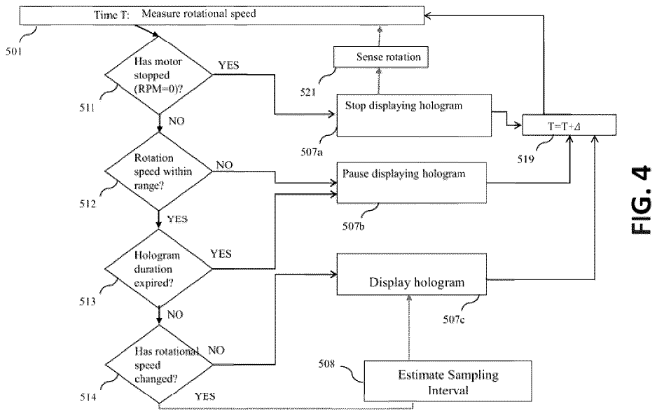

To further clarify, there is provided an exemplary method in FIG. 4 that provides a flowchart showing basic steps of the procedure. In step 501, speed sensor 228 measures at time T a different speed than what was measured at the previous measurement time, (T−Δ), where the speed measurement increment timer A is configurable. Accordingly, holograph driver 227 checks at checkbox 511 if the hologram fan assembly has stopped turning. If yes, it stops playing the hologram in step 507a. This happens, for example, when a car's wheel stops at a traffic light. Otherwise, in checkbox 512, it checks to determine if the rotation speed is less than the configured minimum speed, in which case it pauses the hologram in step 507b. Optionally, at this step, it can provide a feedback to the motorized system (comprising rotatable blades) to increase its speed (i.e. increase rotation speed of blades) to display the hologram. Then, in checkbox 513, it checks to determine if there is a hologram display timer and whether that timer has expired, and if so, it goes to step 507b to pause showing the hologram. This timer is also a configurable parameter. In another arrangement, after determining that the rotation speed is within range (but has not stopped), the controller is configured to check if a predetermined time has lapsed. For instance, when the hologram to be displayed has to move through a pre-programmed sequence of holograms, such as when there is a change of animation (e.g., from boy to girl, from child to senior), which may include a change of action (e.g., from standing to bowing). Otherwise, the exemplary method checks to determine if the measured rotational speed has changed in checkbox 514. If not, it displays the hologram in step 507c. If the rotational speed has changed, before displaying the hologram, sample interval estimator 217 determines the new sampling interval at step 508. Display of hologram includes all the steps required to convert binary sequence at sampling interval (ΔT) to electric pulses by LED driver 237.

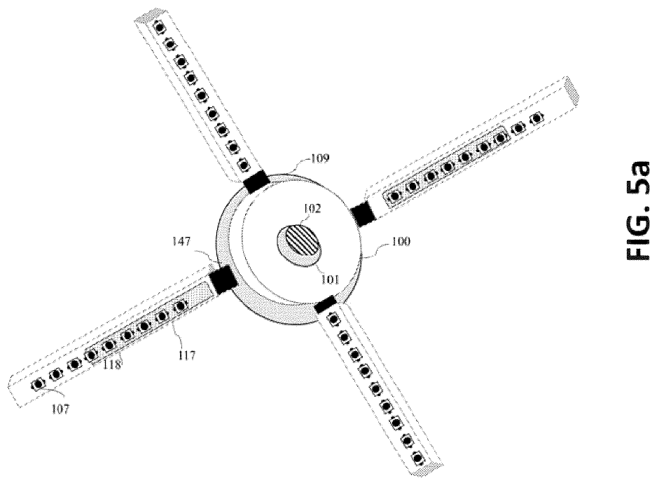

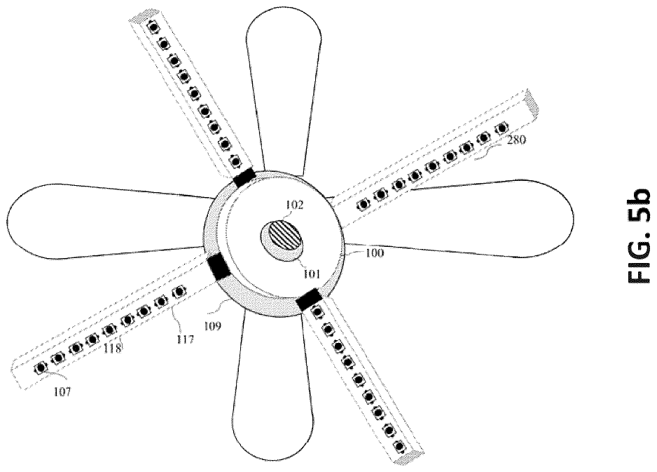

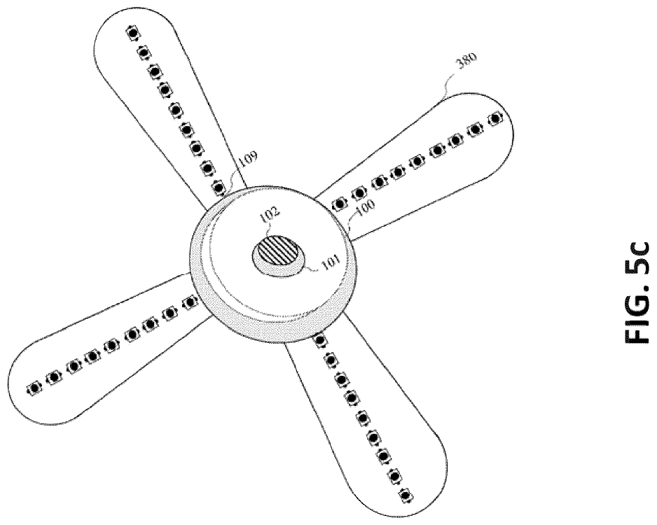

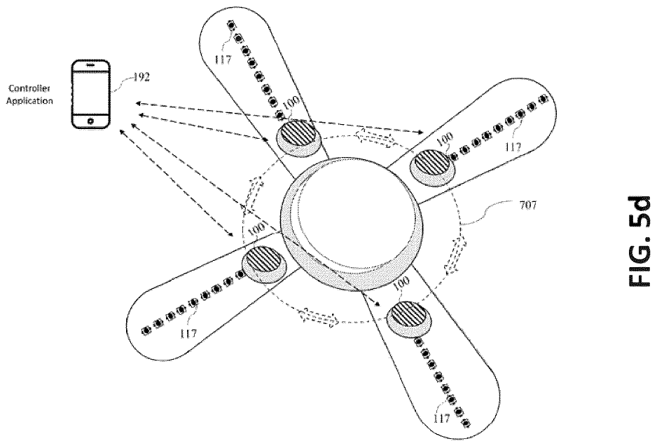

FIGS. 5a, b, c and d show various embodiments of the hologram fan assembly (or hologram fan system) according to invention, FIG. 5a shows how the hologram fan system looks from underneath the blades for a four-blade hologram system. Note that the figure is not drawn to scale nor does it have all the hologram fan assembly details. Core 100, four blades 117, battery 101 and solar panel 102 attached to core are illustrated. The battery can be charged in a variety of ways: (i) charged by a solar panel mounted on the core, (ii) the battery is removed from the core and charged using an external charger, and (iii) battery stays in place and gets charged using a USB cable. In the case a USB connection is involved, it should be appreciated that the USB connector of the USB connection can be any of its different types such as the conventional USB connector (Type A; USB 3.0), USB Type-C, Micro-USB, etc. Other similar types of connectors like 8-pin Lightning (e.g., for iPhone) can be used as well. Other obvious battery charging alternatives are covered by this invention. All components turn at a rotational speed of an external rotational system where the hologram fan assembly is attached with a mounting adapter (not shown in the figure). In FIG. 5b, the hologram fan assembly of FIG. 5a is attached to a cooling fan (e.g., an indoor/outdoor fan or computer fan) as an exemplary implementation through a mounting adapter. Only the mounting adapter differs from one type of rotating external assembly to another. There is no internal motor in the hologram fan assembly. All components including core 100 and blades 117 remain identical.

In another example shown in FIG. 5d, a complete single-blade hologram fan assembly system including core 100 and LED string 117 is installed on each blade of an n-blade cooling fan, with controller application 192 communicating with each single-blade system so as to govern the operation as an n-blade system. An optional communication means 707 (e.g. WIFI or Bluetooth) between each single-blade fan assembly system may allow controller application 192 to communicate with only a master single-blade system and to rely on a master-slave configuration employed among the blades using communications means 707. Controller application 192 is configured to store the 3D image files and the configuration settings of the Blade/LED topology that can be adjusted to according to the number of blades added/deleted. In this embodiment, core 100 is implemented n times in an n-blade system, and the n batteries is required for charging each core 100. It provides graceful (robust) system evolution by allowing one to start with a system of much fewer number of blades, and allow upgrading to add more blades later. The Controller application 192 may be an application installed in a device such as a smartphone, a tablet computer, a desktop computer, a portable computer and the like.

Like the example in FIG. 5b, no internal motor is required for the abovementioned example that is directed to ceiling fan assembly. Advantageously, the hologram fan assemblies (that does not require an internal motor) described will enable installation on existing external rotating assemblies and bring about a wider reach of hologram applications. In the example directed to ceiling fan assembly, the mounting adapter (e.g., 109 in FIG. 2) may be a bracket that snap fits to a portion of a blade (e.g., 117 in FIG. 2) of the ceiling fan assembly. The core (e.g. 100 in FIG. 2) can be smaller in size and integrated with the mounting adapter in a way that the blade of the hologram fan assembly is firmly (but detachably) attached to the mounting adapter. In addition, the LED of the blade of hologram fan is communicatively coupled to the microprocessor of the core.

In FIG. 5c, the hologram fan assembly of FIG. 5a is embedded (instead of being attached) into cooling fan (e.g., an indoor/outdoor fan or computer fan) as another exemplary implementation to eliminate the need of a special mounting adapter. Note that in this topology, fan assembly blades 117 is embedded into fan blades and core 100 is embedded into the fan's central hub that has the motor components. In this example, a speed sensor (e.g., tachometer) may not be required, because the processor of the core 100 can be configured to obtain the settings (e.g., discrete speed levels) of the cooling fan to derive the respective rotating speed. The generation and display of the 3D image can then be subsequently adjusted at variable rotational speeds without requiring the core 100 to perform a major computation of the corresponding LED pulse sequence that lights up each RGB diode of LED 107 on blade 117 according to light intensity data of a stored image file. This assembly will be a specialized implementation.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

FIG. 3 shows the key software components of controller 104. The 3D image files are stored in local memory 206. The configuration of the system 207 is also stored in local memory. The configuration can be modified using local GUI 209b or through wireless remote terminal 192 that may be a custom remote controller or an application on a cell phone. Controller 104 provides an optional USB interface 209c to change configuration through a wired terminal such as a computer. The system configuration changes are managed by Controller interface 211.

Controller 104 provides wireless communications through module 209a that supports wireless protocols over TCP and UDP. Controller 104 has a rotation speed sensor 228 that can detect the rotation speed every time increment and report to LED intensity mapper 217 that can determine sampling interval according to detected rotation speed given a reference rotation speed. Depending on detected speed relative to the reference speed, it may increase or decrease the sampling time interval to attain a quality of image that correspond to reference speed.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled of interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and the described program components and systems can generally be integrated together in a single software product or packaged into multiple software products.

As noted above, embodiments of the subject matter have been described, but other embodiments are within the scope of the following claims. For example, the actions recited in the claims can be performed in a different order and still achieve desirable results. As one example, the processes depicted in the accompanying figures do not necessarily require the order shown, or sequential order, to achieve desirable results. In certain implementations, multitasking and parallel processing may be advantageous.

1. A 3D holographic fan system for display of 3D images, the system consisting of a non-motorized housing assembly that attaches to or embedded into a motorized system rotating at a rotation speed that varies over time, the 3D holographic fan system having the following components:
a. a fan blade assembly comprised of a plurality of fan blades, wherein a string of (RGB) LEDs are embedded or mounted onto on each fan blade,
b. a core to which the fan blade assembly is mounted peripherally, wherein said core rotating at the same speed with the fan blade assembly, said core having a local power supply and a controller that controls the electricity given to each RGB LED to reflect a 3D image (hologram) in the air in front of the system while the motorized system turns, the controller further being comprised of the following subcomponents:
i. mapper configured to convert a hologram image file into a binary data representing each RGB LED's illumination sequence at a configurable reference rotation speed;
ii. speed sensor configured to measure the rotation speed of the motorized system in real-time;
iii. Sampling interval estimator configured to re-adjust the sampling time interval when measured rotation speed has a discrepancy from the reference rotation speed so as to keep the mapping of said image file to the RGB LED's illumination sequence fixed;
iv. Hologram driver configured to send binary data sequence at the re-adjusted sampling interval to a LED driver, wherein the LED driver is configured to convert said binary data to electric pulses and to deliver pulses to RGB LEDs according to the re-adjusted sampling interval; and
v. Storage configured to store hologram image file, LED illumination file, and fan assembly configuration parameters.

2. The 3D holographic fan system of claim 1, wherein power supply is a DC battery, a lithium battery, or a slip ring.

3. The 3D holographic fan system of claim 1, wherein the controller is operatively connected to a wireless remote device configured to receive the 3D hologram image file to display from another remote storage system and configure the 3D holographic fan system.

4. The 3D holographic fan system of claim 1, wherein the local power supply is charged internally by a solar panel or externally using a USB connection.

5. The 3D holographic fan system of claim 1, wherein the core and the fan blade assembly are detachably attached to a mounting adapter that firmly fits the fan blade assembly to different type and size of motorized systems.

6. The 3D holographic fan system of claim 1, wherein the motorized system is a computer fan to cool the computer components by circulating air.

7. The 3D holographic fan system of claim 1, wherein the motorized system is any type of ceiling, window, desk, tower, pedestal, or handheld fan, or any type of fan mounted to furniture for indoors and outdoors air cooling.

8. The 3D holographic fan system of claim 1, wherein the motorized system is
a rotating wheel of a car, truck, van or another type of vehicle.

9. The 3D holographic fan system of claim 1, wherein the motorized system is part of an unmanned aerial device or a helicopter.

10. The 3D holographic fan system of claim 1, wherein the multiplication of sampling time interval and measured rotation speed is fixed such that when the measured rotation speed increases, the sampling time is proportionally reduced, and when the measured rotation speed decreases, the sampling time is proportionally increased.

11. The 3D holographic fan system of claim 1, wherein the sampling time interval is varied based on the difference between the measured rotation speed and the reference rotation speed, if the controller determines that the measured rotation speed is more than or equal to a specified minimum speed.

13. The 3D holographic fan system of claim 1, wherein the electric pulses corresponding to the binary data representing the LED pulse sequence is sent out more frequently to LEDs when the measured rotation speed is higher than the reference rotation speed, and less frequently when the measured rotation speed is lower than the reference rotation speed.

14. The 3D holographic fan system of claim 1, wherein the controller is configured to communicate with the motorized system to enable rotation at a speed that meets or exceeds a specified minimum speed.

15. A method of the controller as claimed in claim 1 for controlling the display of hologram according to the following steps:
a. measuring current rotation speed of the motorized system using the speed sensor;
b. stop displaying of hologram when current rotation speed is zero;
c. pause displaying of hologram when current rotation speed is less than a specified minimum speed, or when a hologram display timer expires;
d. otherwise, determining a current sampling interval by taking the ratio of a specified reference rotation speed to a measured current rotation speed and multiplying said ratio by a reference sampling interval corresponding to the reference rotation speed; and
e. displaying a hologram at the current sampling interval.

16. A 3D holographic fan system for display of 3D images, the system consisting of a non-motorized housing assembly that attaches to or embedded into a motorized system rotating at a rotation speed that varies over time, the 3D holographic fan system having the following components mounted onto one or more fan blades of an n-blade fan:
a. a single hologram production blade that is comprised of a string of a plurality of (RGB) LEDs,
b. a core to which the single hologram production blade is attached, wherein said core having a local power supply and a controller that controls the electricity given to each RGB LED to reflect a 3D image (hologram) in the air in front of the system while the motorized system turns, the controller further being comprised of the following subcomponents:
i. mapper configured to convert a hologram image file into a binary data representing each RGB LED's illumination sequence at a configurable reference rotation speed;
ii. speed sensor configured to measure the rotation speed of the motorized system in real-time;
iii. Sampling interval estimator configured to re-adjust the sampling time interval when measured rotation speed has a discrepancy from the reference rotation speed so as to keep the mapping of said image file to the RGB LED's illumination sequence fixed;
iv. Hologram driver configured to send binary data sequence at the re-adjusted sampling interval to a LED driver, wherein the LED driver is configured to convert said binary data to electric pulses and to deliver pulses to RGB LEDs according to the re-adjusted sampling interval; and
v. Storage configured to store hologram image file, LED illumination file, and fan assembly configuration parameters,
c. A communication means between a remote control application and the core of each hologram blade to coordinate the operate as a system of n-blades.
